(19) United States
(12) Patent Application Publication
(10) Pub. No.: US 2026/0318575 A1
(43) Pub. Date: Oct. 15, 2026

(54) AIR-CONDITIONER CONTROL SYSTEM, INFORMATION PROCESSING APPARATUS AND AIR-CONDITIONER CONTROL METHOD

(71) Applicant: DAIKIN INDUSTRIES, LTD., Osaka (JP)

(72) Inventors: Yukio KITADE, Osaka (JP); Masanori YAGETA, Osaka (JP); Kazuhito SEMBA, Osaka (JP)

(21) Appl. No.: 19/104,836

(22) PCT Filed: Jun. 6, 2023
(86) PCT No.: PCT/JP2023/020945

§ 371 Date: Feb. 19, 2025

(30) Foreign Application Priority Data
Sep. 30, 2022 (JP) 2022-158318

(51) Int. Cl. F25B 49/00; G01M 3/26

(52) U.S. Cl. CPC F25B 49/00; G01M 3/26; F25B 2500/222; F25B 2700/19

(57) ABSTRACT

An air-conditioner control system including a control unit for controlling an air conditioner, the control unit being configured to:
execute first refrigerant detection control, in which a refrigerant leakage detection for the air conditioner is performed every first predetermined period of time, based on a state of a refrigerant occurring when the air conditioner is running or based on a pressure of the refrigerant occurring when the air conditioner is not running; and
execute, when a second predetermined period of time has elapsed since the air conditioner was run last time, second refrigerant detection control, in which the refrigerant leakage detection for the air conditioner is performed while the air conditioner is running, for a refrigerant leakage detection purpose.

### TECHNICAL FIELD

The present disclosure relates to an air-conditioner control system, an information processing apparatus, and an air-conditioner control method.

### BACKGROUND ART

There is a system for detecting an amount of refrigerant. This system allows an operation mode refrigeration cycle device to be switched automatically or manually from a normal operation mode to a refrigerant amount detection operation mode when the refrigeration cycle device's cooling or heating operation lasts for a certain period of time, so that whether the refrigerant is leaking from the refrigeration circuit to the outside can be monitored remotely (see, for example, patent document 1).

### CITATION LIST

### Patent Documents

Patent Document 1: Unexamined Japanese Patent Application No. 2009-079842

### SUMMARY OF THE INVENTION

### Problem to be Solved by the Invention

Patent document 1 detects a refrigerant leakage by switching the operation mode of a refrigeration cycle device from a normal operation mode to a refrigerant amount detection operation mode during times when air-conditioning is not needed, such as holidays, late night hours, and so forth. However, patent document 1 fails to teach convenient refrigerant leakage detection.

The present disclosure therefore aims to provide an air-conditioner control system, an information processing apparatus, and air-conditioner control method that enable convenient and reliable refrigerant leakage detection.

### Means for Solving the Problem

A first example of the present disclosure provides an air-conditioner control system including a control unit for controlling an air conditioner. The control unit is configured to:
execute first refrigerant detection control, in which a refrigerant leakage detection for the air conditioner is performed every first predetermined period of time, based on a state of a refrigerant occurring when the air conditioner is running or based on a pressure of the refrigerant occurring when the air conditioner is not running; and
execute, when a second predetermined period of time has elapsed since the air conditioner was run last time, second refrigerant detection control, in which the refrigerant leakage detection for the air conditioner is performed while the air conditioner is running, for a refrigerant leakage detection purpose.

According to the first example of the present disclosure, it is possible to provide an air-conditioner control system that enables convenient refrigerant leakage detection.

A second example of the present disclosure is based on the air-conditioner control system of the first example, and the control unit is configured to perform the refrigerant leakage detection for the air conditioner based on the pressure of the refrigerant occurring when the air conditioner is not running, when the refrigerant leakage detection for the air conditioner based on the state of the refrigerant occurring when the air conditioner is running is not performed for the first predetermined period of time.

A third example of the present disclosure is based on the air-conditioner control system of the first example or the second example, and the control unit is configured to execute control such that, when a result of the second refrigerant detection control indicates that the refrigerant is leaking, an indication to an effect that the refrigerant is leaking or a suggestion for an inspection of the air conditioner is sent to a predetermined destination.

A fourth example of the present disclosure is based on the air-conditioner control system of any one of the first example to the third example, and the second refrigerant detection control includes performing the refrigerant leakage detection for the air conditioner based on the state of the refrigerant for the air conditioner occurring when the air conditioner is running at a load that is 70% or more of a capacity of the air conditioner.

A fifth example of the present disclosure is based on the air-conditioner control system of the fourth example, and the second refrigerant detection control includes performing the refrigerant leakage detection for the air conditioner based on the state of the refrigerant for the air conditioner occurring after the air conditioner is run at the load for a third predetermined period of time or longer.

A sixth example of the present disclosure is based on the air-conditioner control system of any one of the first example to the fifth example, and the second predetermined period of time is less than three months.

A seventh example of the present disclosure is based on the air-conditioner control system of any one of the first example to the sixth example, and the control unit records information indicating that the second refrigerant detection control has been executed.

An eighth example of the present disclosure provides an information processing apparatus including a control unit for controlling an air conditioner. The control unit is configured to:
execute first refrigerant detection control, in which a refrigerant leakage detection for the air conditioner is performed every first predetermined period of time, based on a state of a refrigerant occurring when the air conditioner is running or based on a pressure of the refrigerant occurring when the air conditioner is not running; and
execute, when a second predetermined period of time has elapsed since the air conditioner was run last time, second refrigerant detection control, in which the refrigerant leakage detection for the air conditioner is performed while the air conditioner is running, for a refrigerant leakage detection purpose.

According to the eighth example of the present disclosure, it is possible to provide an information processing apparatus that enables convenient refrigerant leakage detection.

A ninth example of the present disclosure provides an air-conditioner control method to be executed by a control unit for controlling an air conditioner in an air-conditioner control system. The method includes:
executing first refrigerant detection control, in which a refrigerant leakage detection for the air conditioner is performed every first predetermined period of time, based on a state of a refrigerant occurring when the air conditioner is running or based on a pressure of the refrigerant occurring when the air conditioner is not running; and
executing, when a second predetermined period of time has elapsed since the air conditioner was run last time, second refrigerant detection control, in which the refrigerant leakage detection for the air conditioner is performed while the air conditioner is running for a refrigerant leakage detection purpose.

According to the ninth example of the present disclosure, it is possible to provide an air-conditioner control method that enables convenient refrigerant leakage detection.

### BRIEF DESCRIPTION OF THE DRAWINGS

FIG. 1 is a diagram that shows an example structure of an air-conditioner control system according to one embodiment of the present disclosure;

FIG. 2 is a diagram that shows an example hardware structure of a computer according to one embodiment of the present disclosure;

FIG. 3 is a flowchart that shows examples of air-conditioner control processes performed by an air-conditioner control system according to one embodiment of the present disclosure;

FIG. 4 is a sequence diagram that shows examples of air-conditioner control processes performed by an air-conditioner control system according to one embodiment of the present disclosure;

FIG. 5 is a sequence diagram that shows examples of air-conditioner control processes performed by an air-conditioner control system according to one embodiment of the present disclosure; and

FIG. 6 is a sequence diagram that shows examples of air-conditioner control processes performed by an air-conditioner control system according to one embodiment of the present disclosure.

### DETAILED DESCRIPTION OF THE PREFERRED EMBODIMENTS

Next, embodiments of the present disclosure will be described in detail.

### First Embodiment

### <System Structure>

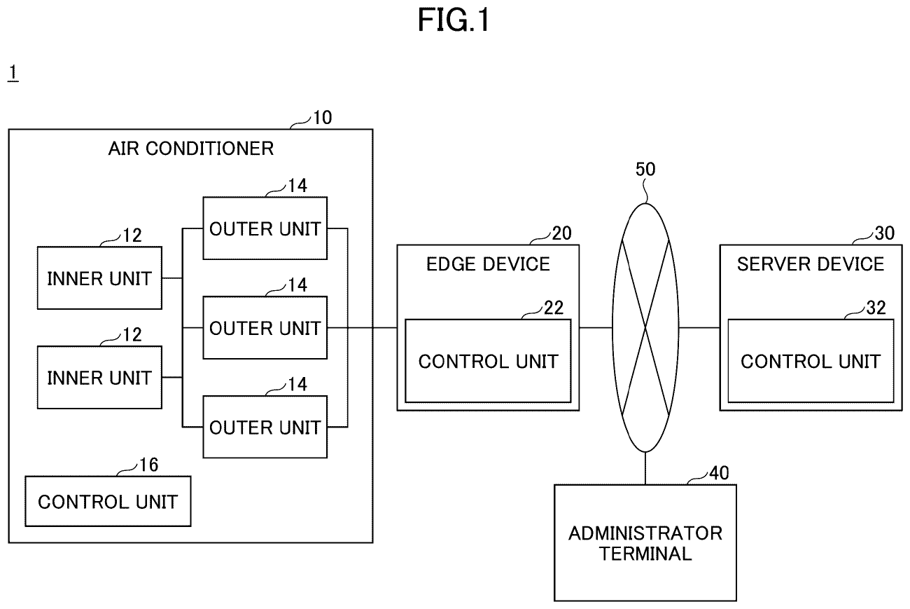

FIG. 1 is a diagram that shows an example structure of an air-conditioner control system according to one embodiment of the present disclosure. An air-conditioner control system 1 has an air conditioner 10, an edge device 20, a server device 30, and an administrator terminal 40. The air conditioner 10 and the edge device 20 are communicatively connected via a dedicated communication line or the like. The edge device 20, the server device 30, and the administrator terminal 40 are communicatively connected via a network 50 such as, for example, the Internet.

The air conditioner 10 has one or more inner units 12 and one or more outer units 14. The number of inner units 12 and outer units 14 that the air conditioner 10 of FIG. 1 has is one example. The inner units 12 and outer units 14 of the air conditioner 10 are connected So that they can communicate with each other. The air conditioner 10 is an example of a device that runs a refrigeration cycle by circulating a refrigerant such as freon.

To allow early detection of a refrigerant leakage, the Fluorocarbon Emissions Control Act requires regular, simple inspections of equipment that uses fluorocarbons as a refrigerant. The use of Internet-of-Things (IoT) systems is permitted as a method for convenient inspections. When using an IoT system, the following requirement is stated. “The pressure, temperature, and other status values necessary to detect a leakage be measured per refrigerant system according to the type of class I specified product. Note that measurements should be taken at least once a day.”

Once the air conditioner 10 is run, a refrigerant leakage check can be performed based on the state of the refrigerant occurring when the air conditioner 10 is running. Also, even while the air conditioner 10 is not run, a once-a-day refrigerant leakage check can be performed based on changes in the refrigerant's pressure. However, in the event the air conditioner 10 is not run for three months or more, the Act on Rational Use and Appropriate Management of Fluorocarbons requires that the air conditioner 10 be inspected at the site where it is installed.

The refrigerant leakage detection for the air conditioner 10 based on the refrigerant's pressure occurring when the air conditioner 10 is not running is less reliable than the refrigerant leakage detection for the air conditioner 10 based on the state of the refrigerant occurring when the air conditioner 10 is running. Also, in the event the refrigerant leakage detection for the air conditioner 10 based on the state of the refrigerant occurring when the air conditioner 10 is running is not performed for three months or more, it is then necessary to send a serviceperson or the like to the site where the air conditioner 10 is installed and inspect the air conditioner 10.

The air-conditioner control system 1 according to one embodiment of the present disclosure therefore aims to ensure once-a-day refrigerant leakage check by performing a convenient refrigerant leakage check based on changes in the refrigerant's pressure occurring when the air conditioner 10 is not running, even when the air conditioner 10 is not run. A day is an example of a first predetermined period of time. Also, the air-conditioner control system 1 according to one embodiment of the present disclosure executes control such that the interval that follows after a refrigerant leakage detection is performed for the air conditioner 10 based on the state of the refrigerant occurring when the air conditioner 10 is running does not exceed three months. Three months is an example of a second predetermined period of time.

Therefore, with the air-conditioner control system 1 according to one embodiment of the present disclosure, refrigerant leakage detection for the air conditioner 10 is performed based on the state of the refrigerant occurring when the air conditioner 10 is running and will not go unperformed for three months or more, so that, for example, there is no need to send a serviceperson or the like to the site where the air conditioner 10 is installed.

Also, the air-conditioner control system 1 according to one embodiment of the present disclosure performs a convenient refrigerant leakage check at least once a day based on the refrigerant's pressure occurring when the air conditioner 10 is not running, and the interval that follows after a refrigerant leakage detection is performed based on the state of the refrigerant occurring when the air conditioner 10 is running for ensuring reliability does not exceed the second predetermined period of time. Thus, even if a convenient inspection results in a detection error, for example, the air-conditioner control system 1 according to one embodiment of the present disclosure can still detect a refrigerant leakage reliably based on the state Of the refrigerant occurring when the air conditioner 10 is running, before the second predetermined period of time is exceeded, so that the amount of refrigerant leakage can be reduced.

The edge device 20 transmits the data output by the air conditioner 10 to the server device 30 via the network 50. The edge device 20 also transmits the data output by the server device 30 to the air conditioner 10 via the network 50.

The server device 30 receives the data output by the air conditioner 10 from the edge device 20 via the network 50. The server device 30 also transmits the data to be output to the air conditioner 10, to the edge device 20.

The administrator terminal 40 is an information processing terminal that is operated by a user who manages the air conditioner 10 (for example, an administrator who manages the building in which the air conditioner 10 is installed, a serviceperson in charge of the air conditioner 10, etc.) The administrator terminal 40 displays the data received from the air conditioner 10, the edge device 20, or the server device 30, and shows their indications to the user. For example, the administrator terminal 40 displays an indication to the effect that the refrigerant is leaking or a suggestion for an inspection of the air conditioner 10, which will be described later. The administrator terminal 40 is an information processing terminal such as a personal computer (PC), a smartphone, a tablet terminal, or the like.

In the air-conditioner control system 1, control programs are installed in at least one of the air conditioner 10, the edge device 20, and the server device 30. The air conditioner 10 can function as a control unit 16 by executing the control programs. The edge device 20 can function as a control unit 22 by executing the control programs. Also, the server device 30 can function as a control unit 32 by executing the control programs.

Note that, although FIG. 1 shows an example in which the air conditioner 10, the edge device 20, and the server device 30 each have a control unit 16, 22, or 32, the structure is by no means limited to that shown in FIG. 1. The air-conditioner control system 1 may have any structure that has at least one of the control units 16, 22, and 32.

The control units 16, 22, and 32 control the air conditioner 10. As will be described later, the control units 16, 22, and 32 perform a refrigerant leakage detection based on first refrigerant detection control for the air conditioner 10, and perform a refrigerant leakage detection based on second refrigerant detection control for the air conditioner 10. When the refrigerant leakage detection based on the first refrigerant detection control for the air conditioner 10 is performed, a refrigerant leakage from the air conditioner 10 may be detected every first predetermined period of time, based on the state of the refrigerant occurring when the air conditioner 10 is running or based on the pressure of the refrigerant occurring when the air conditioner 10 is not running. In the event that the refrigerant leakage detection based on the second refrigerant detection control for the air conditioner 10 is performed, a refrigerant leakage from the air conditioner 10 may be detected while the air conditioner 10 is running in the refrigerant leakage detection mode when a second predetermined period of time has elapsed since the air conditioner 10 was run last time. For example, the control unit 32 of the server device 30 can control the air conditioner 10 remotely via the network 50.

The structure of the air-conditioner control system 1 shown in FIG. 1 is one example, and, for example, the server device 30 may be implemented by one or more information processing apparatuses. The server device 30 may also be implemented as cloud computing services. Obviously, there are various example structures for the structure of the air-conditioner control system 1 of FIG. 1, depending on the application and purpose of use.

### <Hardware Structure>

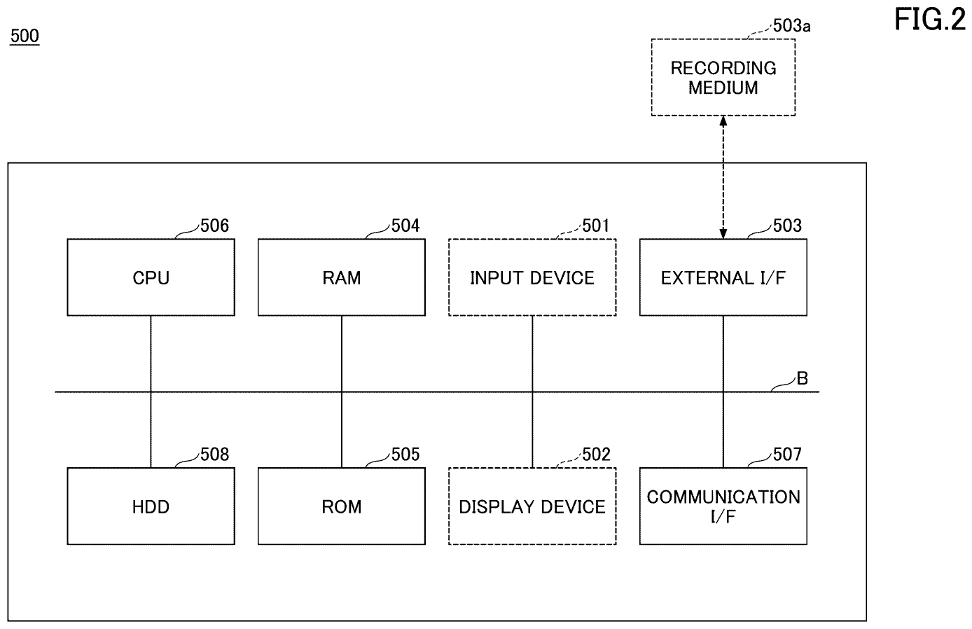

The edge device 20, server device 30, and administrator terminal 40 in FIG. 1 are implemented, for example, by a computer 500 having the hardware structure shown in FIG. 2. Also, the air conditioner 10 has a controller that is similar to the computer 500 that can execute control programs.

FIG. 2 is a diagram that shows an example hardware structure of a computer according to one embodiment of the present disclosure. The computer 500 of FIG. 2 includes an input device 501, a display device 502, an external I/F 503, a RAM 504, a ROM 505, a CPU 506, a communication I/F 507, and an HDD 508, all of which are connected to each other via a bus B. Note that the input device 501 and the display device 502 may be connected and used on an as-needed basis.

The input device 501 may be a touch panel, operation keys, buttons, keyboard, mouse, and the like that the user uses to input various signals. The display device 502 is composed of a display such as an LCD or OLED that displays a screen, a speaker that outputs sound data such as voice and music, and so forth. The communication I/F 507 is an interface through which the computer 500 performs data communication over a network.

Also, the HDD 508 is an example of a non-volatile storage device that stores programs and data. The programs and data to be stored in the HDD 508 include an OS, which is basic software that controls the entire computer 500, and applications that provide various functions on the OS. Note that, instead of the HDD 508, the computer 500 may use a drive device that uses a flash memory as a recording medium (for example, a solid-state drive (SSD)).

The external I/F 503 is an interface with external devices. External devices include a recording medium 503a, for example. This allows the computer 500 to read from and write to the recording medium 503a via the external I/F 503. Examples of the recording medium 503a include a flexible disk, a CD, a DVD, an SD memory card, and a USB memory.

The ROM 505 is an example of a non-volatile semiconductor memory (storage device) that can hold programs and data even when the power is turned off. The ROM 505 stores programs and data such as the BIOS, OS configurations, and network configurations that are executed when the computer 500 is powered on. The RAM 504 is an example of a volatile semiconductor memory (storage device) that holds programs and data on a temporary basis.

The CPU 506 is a computing device that reads programs and data from storage devices such as the ROM 505 and HDD 508 onto the RAM 504, and executes processes to implement the control and functions of the entire computer 500. The CPU 506 is an example of the control unit 16, 22, or 32.

### <Processes>

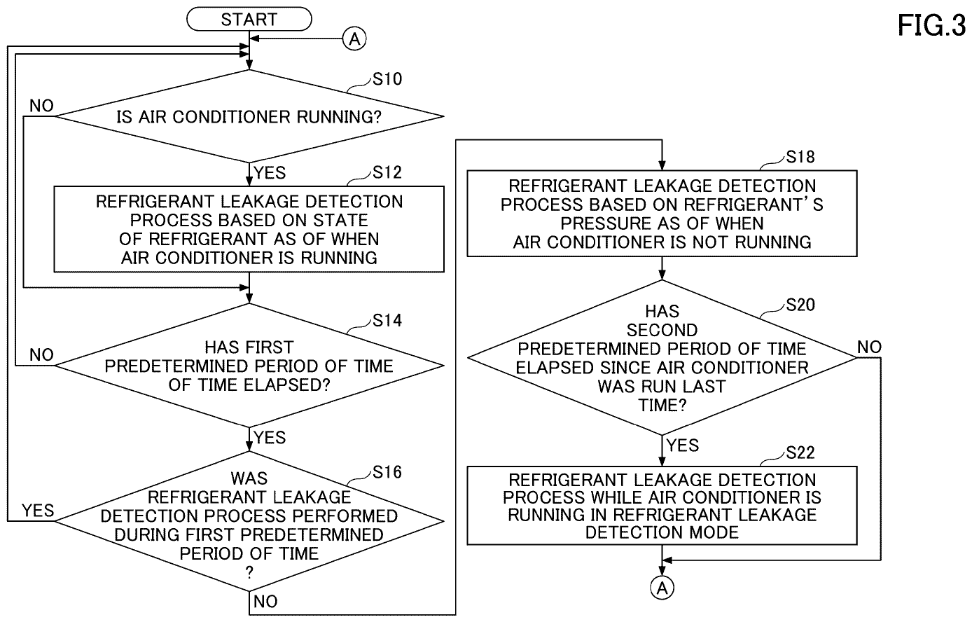

The air-conditioner control system 1 of FIG. 1 performs air-conditioner control processes as shown in FIG. 3, for example. FIG. 3 is a flowchart that shows examples of air-conditioner control processes performed by the air-conditioner control system according to one embodiment of the present disclosure. Here, an example will be described in which the control unit 32 of the server device 30 controls the air conditioner 10 remotely via the network 50.

In step S10, the control unit 32 determines whether the air conditioner 10 is running. If the air conditioner 10 is running, the control unit 32 proceeds to step S12, and, among the refrigerant leakage detection processes that the control unit 32 may perform based on the first refrigerant detection control for the air conditioner 10, performs the refrigerant leakage detection process based on the state of the refrigerant occurring when the air conditioner 10 is running. If the result of the refrigerant leakage detection process indicates that the refrigerant is leaking, the control unit 32 displays an indication to the effect that the refrigerant is leaking or a suggestion for an inspection of the air conditioner 10 on the administrator terminal 40. The administrator terminal 40 is an example of a destination to which such an indication is sent. In this way, when the air conditioner 10 is running, the presence or absence of a refrigerant leakage is determined based on the state of the refrigerant occurring when the air conditioner 10 is running.

If the air conditioner 10 is not running, the control unit 32 skips step S12 and proceeds to the process of step S14. In step S14, the control unit 32 determines whether one day has elapsed. One day is an example of the first predetermined period of time. If one day has not elapsed, the control unit 32 returns to the process of step S10.

If one day has elapsed, the control unit 32 proceeds to the process of step S16. In step S16, the control unit 32 determines whether or not the refrigerant leakage detection process was performed within the last one-day-long period. If the refrigerant leakage detection process was performed within the last one-day-long period, the control unit 32 determines that a refrigerant leakage check is performed once a day, and returns to the process of step S10.

If the refrigerant leakage detection process was not performed within the last one-day-long period, the control unit 32 determines that a once-a-day refrigerant leakage check is not performed, and proceeds to the process of step S18. In step S18, among the refrigerant leakage detection processes that the control unit 32 may perform based on the first refrigerant detection control for the air conditioner 10, the control unit 32 performs the process of detecting a refrigerant leakage based on the refrigerant's pressure occurring when the air conditioner 10 is not running.

The refrigerant leakage detection process, in which a refrigerant leakage is detected based on the refrigerant's pressure occurring when the air conditioner 10 is not running, is an example of control for performing convenient (simple) refrigerant leakage detection, in which the air conditioner 10 need not be run to detect a refrigerant leakage. The refrigerant leakage detection process, in which a refrigerant leakage is detected based on the refrigerant's pressure occurring when the air conditioner 10 is not running, determines that the refrigerant is leaking by detecting the refrigerant's pressure using a pressure sensor. If the result of the refrigerant leakage detection process indicates that the refrigerant is leaking, the control unit 32 displays an indication to the effect that the refrigerant is leaking or a suggestion for an inspection of the air conditioner 10 on the administrator terminal 40. The administrator terminal 40 is an example of a destination to which such an indication is sent.

In step S20, the control unit 32 determines whether or not the second predetermined period of time has elapsed since the air conditioner 10 was run last time. The second predetermined period of time is, for example, less than three months. Given the Fluorocarbon Emissions Control Act, the second predetermined period of time here is, for example, a period that is shorter than the period of time that makes it necessary to send a serviceperson or the like to the site where the air conditioner 10 is installed.

If the second predetermined period of time has not elapsed since the air conditioner 10 was run last time, the control unit 32 returns to the process of step S10. If the second predetermined period of time has elapsed since the air conditioner 10 was run last time, the control unit 32 proceeds to the process of step S22.

In step S22, the control unit 32 performs the refrigerant leakage detection process for the air conditioner 10 based on the second refrigerant detection control. In the refrigerant leakage detection process for the air conditioner 10 based on the second refrigerant detection control, a refrigerant leakage may be detected for the air conditioner 10 while the air conditioner 10 runs in the refrigerant leakage detection mode. In the refrigerant leakage detection process for the air conditioner 10 based on the second refrigerant detection control, a refrigerant leakage may be detected based on the state of the refrigerant for the air conditioner 10 occurring when the air conditioner 10 is running at a predetermined level of load or more (for example, 70% or more). For example, in the refrigerant leakage detection process based on the second refrigerant detection control for the air conditioner 10, the air conditioner 10 may be run such that a load is placed on a predetermined number of inner units 12 (for example, 70% or more of all the inner units 12) for a predetermined period of time (for example, approximately one hour) or more, and a refrigerant leakage may be detected for the air conditioner 10 based on the state of the refrigerant for the air conditioner 10 after the refrigerant for the air conditioner 10 becomes stable. For example, when the air conditioner 10 is run such that a load of 70% or more is placed on the inner units 12, this means that a load that is 70% or more of the rated capacity of the outer units 14 is placed on the inner units 12 (the capacity of the working inner units 12 becomes 70% or more of the rated capacity of the outer units 14). In other examples, the operation in which a load of 70% or more is placed may refer to an operation in which 70% or more of the connecting inner units 12 are run, or refer to an operation in which a load that is 70% or more of the total capacity of all the inner units 12 connected to the same system is placed.

If the result of the refrigerant leakage detection process indicates that the refrigerant is leaking, the control unit 32 displays an indication to the effect that the refrigerant is leaking or a suggestion for an inspection of the air conditioner 10 on the administrator terminal 40. The administrator terminal 40 is an example of a destination to which such an indication is sent.

In this way, the air-conditioner control system 1 according to one embodiment of the present disclosure can ensure a once-a-day refrigerant leakage check by performing a refrigerant leakage detection process based on first refrigerant detection control, which includes a convenient refrigerant leakage detection process for detecting a refrigerant leakage based on the refrigerant's pressure occurring when the air conditioner 10 is not running, every first predetermined period of time.

Also, the air-conditioner control system 1 according to one embodiment of the present disclosure can perform reliable refrigerant leakage detection based on the state of the refrigerant occurring when the air conditioner 10 is running before more than three months have elapsed since the air conditioner 10 was run last time. The air-conditioner control system 1 according to one embodiment of the present disclosure thus enables convenient and reliable refrigerant leakage detection.

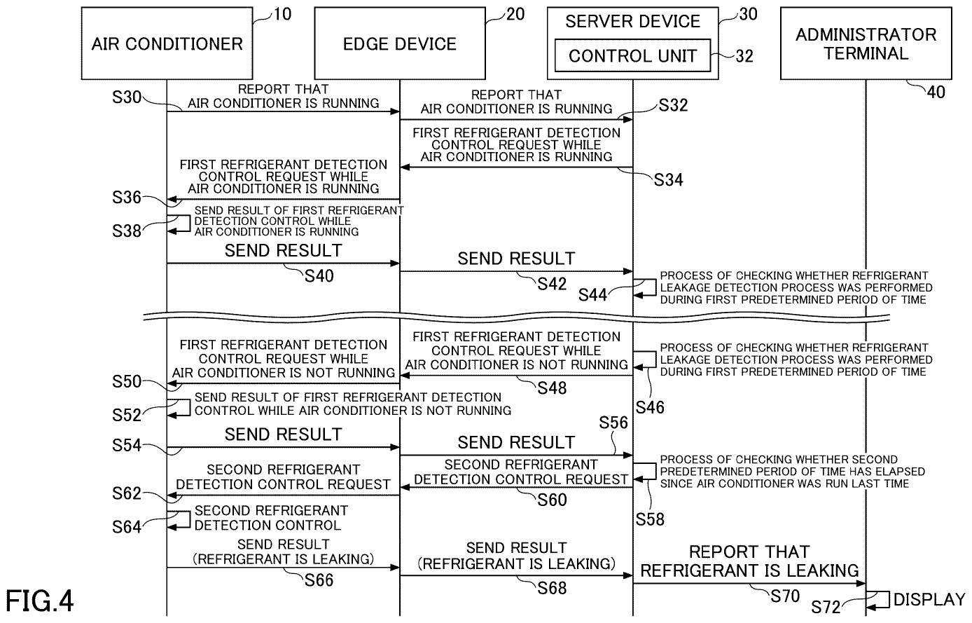

FIG. 4 is a sequence diagram that shows examples of air-conditioner control processes performed by an air-conditioner control system according to one embodiment of the present disclosure. Here, an example will be described in which the control unit 32 of the server device 30 controls the air conditioner 10 remotely via the network 50.

In step S30, the air conditioner 10 reports to the edge device 20 that it has started running. The edge device 20 reports to the control unit 32 of the server device 30 that it has started running. In step S34, the control unit 32 makes a request to the edge device 20 to perform the refrigerant leakage detection process based on the first refrigerant detection control while the air conditioner 1 running. In step S36, the edge device 20 makes a request to the air conditioner 10 to perform the refrigerant leakage detection process based on the first refrigerant detection control while the air conditioner 10 is running.

In step S38, the air conditioner 10 performs a refrigerant leakage detection process based on the first refrigerant detection control while the air conditioner 10 is running, in accordance with the request from the edge device 20. Below, the explanation will continue assuming that the result of the first refrigerant detection control executed while the air conditioner 10 is running in step S38 does not indicate that refrigerant is leaking.

In step S40, the air conditioner 10 reports to the edge device 20 that the refrigerant is not leaking. In step S42, the edge device 20 reports to the control unit 32 of the server device 30 that the refrigerant is not leaking. The control unit 32 records the reported result of the refrigerant leakage detection process.

In step S44, the control unit 32 determines whether the refrigerant leakage detection process was performed for the air conditioner 10 within the last one-day-long period. One day is an example of the first predetermined period of time. Here, because the refrigerant leakage detection process is performed based on the first refrigerant detection control while the air conditioner 10 is running in step S38, the control unit 32 determines that the refrigerant leakage detection process is performed once a day. Because the control unit 32 determines that the refrigerant leakage detection process is performed once a day, the control unit 32 does not make a request to the air conditioner 10 to perform the refrigerant leakage detection process, in which a refrigerant leakage is detected based on the refrigerant's pressure occurring when the air conditioner 10 is not running.

In step S46, the control unit 32 determines whether or not the refrigerant leakage detection process was performed for the air conditioner 10 within the last one-day-long period. Here, the control unit 32 determines that the refrigerant leakage detection process is not performed once a day. Since the control unit 32 determines that the refrigerant leakage detection process is not performed once a day, the control unit 32 proceeds to step S48.

In step S48, the control unit 32 makes a request to the edge device 20 to perform the refrigerant leakage detection process based on the first refrigerant detection control while the air conditioner 10 is not running. In step S50, the edge device 20 makes a request to the air conditioner 10 to perform the refrigerant leakage detection process based on the first refrigerant detection control while the air conditioner 10 is not running.

In step S52, the air conditioner 10 performs the refrigerant leakage detection process based on the first refrigerant detection control while the air conditioner 10 is not running, in accordance with the request from the edge device 20. Below, the explanation will continue assuming that the result of the first refrigerant detection control executed while the air conditioner is not running in step S52 does not indicate that the refrigerant is leaking.

In step S54, the air conditioner 10 reports to the edge device 20 that the refrigerant is not leaking. In step S56, the edge device 20 reports to the control unit 32 of the server device 30 that the refrigerant is not leaking. The control unit 32 records the refrigerant leakage detection's result as reported.

In step S58, the control unit 32 determines whether or not the second predetermined period of time has elapsed since the air conditioner 10 was run last time. Here, assume that the second predetermined period of time has elapsed since the air conditioner 10 was run last time.

In step S60, the control unit 32 makes a request to the edge device 20 to perform the refrigerant leakage detection process based on the second refrigerant detection control. In step S62, the edge device 20 makes a request to the air conditioner 10 to perform the refrigerant leakage detection process based on the second refrigerant detection control.

In step S64, the air conditioner 10 performs the refrigerant leakage detection process based on the second refrigerant detection control in accordance with the request from the edge device 20. Below, the explanation will continue assuming that the result of the second refrigerant detection control in step S64 indicates that the refrigerant is leaking.

In step S66, the air conditioner 10 reports to the edge device 20 that the refrigerant is leaking. Also, in step S68, the edge device 20 reports to the control unit 32 of the server device 30 that the refrigerant is leaking.

Because the result of the second refrigerant detection control in step S64 indicates that the refrigerant is leaking, in step S70, the control unit 32 performs a process of indicating to the administrator terminal 40 that the refrigerant is leaking. The administrator terminal 40 is an example of a destination to which such an indication is sent. Note that the sending of an indication in step S70 may instead be a process of suggesting an inspection of the air conditioner 10. In step S72, the administrator terminal 40 displays an indication to the effect that the refrigerant is leaking or a suggestion for an inspection of the air conditioner 10. Also, in the sending of an indication in step S70, an indication to the effect that refrigerant leakage detection based on the second refrigerant detection control has been performed in the air conditioner 10.

Note that, before making a request to the edge device 20 to perform the refrigerant leakage detection process based on the second refrigerant detection control for the air conditioner 10 in step S60, the control unit 32 may ask the user of the administrator terminal 40 whether or not the refrigerant leakage detection process based on the second refrigerant detection control for the air conditioner 10 can be performed. For example, the control unit 32 may display screen on the administrator terminal 40 asking whether or not the refrigerant leakage detection process based on the second refrigerant detection control for the air conditioner 10 can be performed, and allow the user to choose whether or not the refrigerant leakage detection process based on the second refrigerant detection control can be performed.

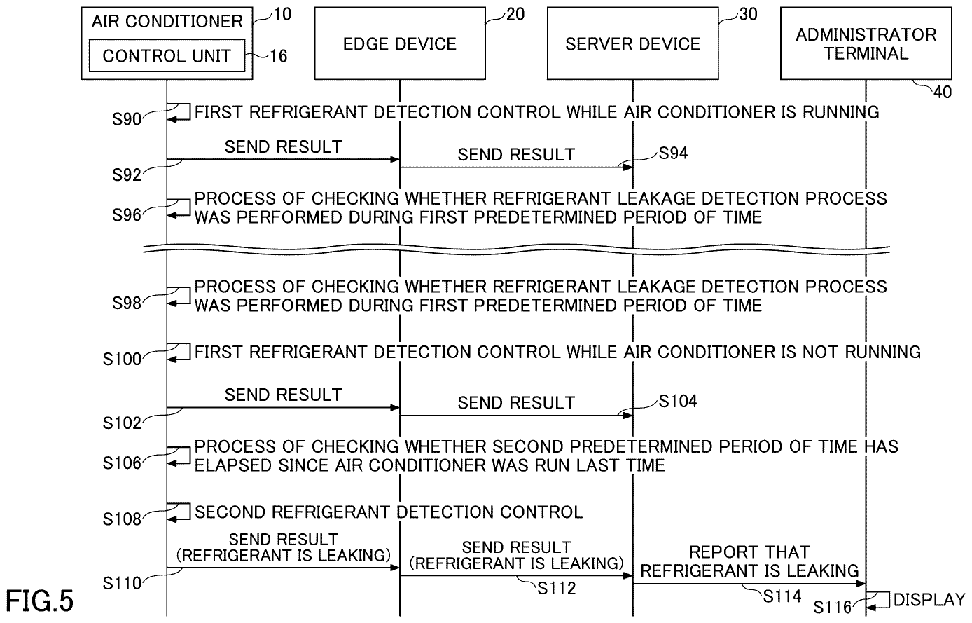

The sequence diagram of FIG. 4 is an example, in which the control unit 32 of the server device 30 determines whether or not the refrigerant leakage detection process based on the first refrigerant detection control for the air conditioner 10 and the refrigerant leakage detection process based on the second refrigerant detection control need to be performed. Whether or not the refrigerant leakage detection process based on the first refrigerant detection control for the air conditioner 10 and the refrigerant leakage detection process based on the second refrigerant detection control need to be performed may be determined by the air conditioner 10, for example, as shown in the sequence diagram of FIG. 5.

FIG. 5 is a sequence diagram that shows examples of air-conditioner control processes performed by an air-conditioner control system according to one embodiment of the present disclosure. Here, an example will be described in which the control unit 16 of the air conditioner 10 determines whether or not the refrigerant leakage detection process based on the first refrigerant detection control and the refrigerant leakage detection process based on the second refrigerant detection control can be executed.

In step S90, when the air conditioner 10 starts running, the control unit 16 of the air conditioner 10 performs the refrigerant leakage detection process based on the first refrigerant detection control while the air conditioner 10 is running. Below, the explanation will continue assuming that the result of the first refrigerant detection control executed while the air conditioner 10 is running in step S90 does not indicate that the refrigerant is leaking.

In step S92, the air conditioner 10 reports to the edge device 20 that the refrigerant is not leaking. In step S94, the edge device 20 reports to the control unit 32 of the server device 30 that the refrigerant is not leaking. The control unit 32 records the refrigerant leakage detection's result as reported.

In step S96, the control unit 16 determines whether the refrigerant leakage detection process was performed within the last one-day-long period. One day is an example of the first predetermined period of time. Here, because the refrigerant leakage detection process is performed based on the first refrigerant detection control while the air conditioner 10 is running in step S90, the control unit 32 determines that the refrigerant leakage detection process is performed once a day. In the example of FIG. 5, because the control unit 32 determines that the refrigerant leakage detection process is performed once a day, the refrigerant leakage detection process for detecting a refrigerant leakage based on the refrigerant's pressure occurring when the air conditioner 10 is not running is not performed.

In step S98, the control unit 16 determines whether or not the refrigerant leakage detection process was performed within the last one-day-long period. Here, assume that the control unit 32 determines that the refrigerant leakage detection process is not performed once a day. The control unit 16 determines that the refrigerant leakage detection process is not performed once a day, and proceeds to the process of step S100.

In step S100, the control unit 16 performs the refrigerant leakage detection process based on the first refrigerant detection control while the air conditioner 10 is not running. Below, the explanation will continue assuming that the result of the first refrigerant detection control executed while the air conditioner 10 is not running in step S100 does not indicate that the refrigerant is leaking.

In step S102, the air conditioner 10 reports to the edge device 20 that the refrigerant is not leaking. In step S104, the edge device 20 reports to the control unit 32 of the server device 30 that the refrigerant is not leaking. The control unit 32 records the refrigerant leakage detection's result as reported.

In step S106, the control unit 16 determines whether or not the second predetermined period of time has elapsed since the air conditioner 10 was run last time. Here, assume that the second predetermined period of time has elapsed since the air conditioner 10 was run last time.

In step S108, the control unit 16 performs refrigerant leakage detection based on the second refrigerant detection control process. Below, the explanation will continue assuming that the result of the second refrigerant detection control in step S108 indicates that the refrigerant is leaking.

In step S110, the control unit 16 reports to the edge device 20 that the refrigerant is leaking. Also, in step S112, the edge device 20 reports to the control unit 32 of the server device 30 that the refrigerant is leaking.

Because the result of the second refrigerant detection control in step S108 indicates that the refrigerant is leaking, in step S114, the control unit 32 performs a process of indicating to the administrator terminal 40 that the refrigerant is leaking. The administrator terminal 40 is an example of a destination to which such an indication is sent. Note that the sending of an indication in step S114 may instead be a process of suggesting an inspection of the air conditioner 10. In step S116, the administrator terminal 40 displays an indication to the effect that the refrigerant is leaking or a suggestion for an inspection of the air conditioner 10.

The control unit 32 of the server device 30 manages the results of the refrigerant leakage detection based on the first refrigerant detection control and the first refrigerant detection control. Note that the these results may be reported together, from the air conditioner 10 to the server device 30, as a daily report.

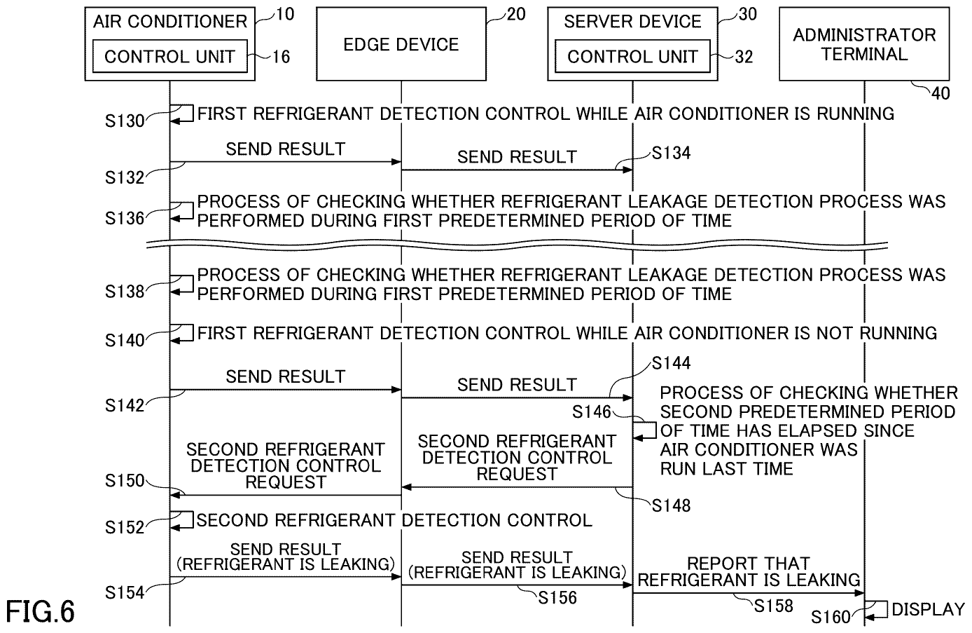

Whether or not the refrigerant leakage detection process based on the first refrigerant detection control for the air conditioner 10 and the refrigerant leakage detection process based on the second refrigerant detection control need to be performed may be determined separately by the control unit 16 of the air conditioner 10 and by the control unit 32 of the server device 30, as shown in FIG. 6. FIG. 6 is a sequence diagram that shows examples of air-conditioner control processes performed by an air-conditioner control system according to one embodiment of the present disclosure.

Note that the processes of steps S130 to S144 are the same as those of steps S90 to S104 in FIG. 5, and so their description will be omitted.

In step S146, the control unit 32 determines whether or not the second predetermined period of time has elapsed since the air conditioner 10 was run last time. Here, assume that the second predetermined period of time has elapsed since the air conditioner 10 was run last time.

In step S148, the control unit 32 makes a request to the edge device 20 to perform the refrigerant leakage detection process based on the second refrigerant detection control. In step S150, the edge device 20 makes a request to the air conditioner 10 to perform the refrigerant leakage detection process based on the second refrigerant detection control.

In step S152, the air conditioner 10 performs the refrigerant leakage detection process based on the second refrigerant detection control in accordance with the request from the edge device 20. Below, the explanation will continue assuming that the result of the second refrigerant detection control in step S152 indicates that the refrigerant is leaking.

In step S154, the air conditioner 10 reports to the edge device 20 that the refrigerant is leaking. Also, in step S156, the edge device 20 reports to the control unit 32 of the server device 30 that the refrigerant is leaking.

Because the result of the second refrigerant detection control in step S152 indicated that the refrigerant was leaking, in step S158, the control unit 32 performs a process of reporting to the administrator terminal 40 that the refrigerant is leaking. The administrator terminal 40 is an example of a destination to which such an indication is sent. Note that the sending of an indication in step S158 may instead be a process of suggesting an inspection of the air conditioner 10. In step 160, the administrator terminal 40 displays an indication to the effect that the refrigerant is leaking or a suggestion for an inspection of the air conditioner 10.

In the sequence diagrams of FIG. 4 to FIG. 6, examples are shown in which the control unit 32 of the server device 30 or the control unit 16 of the air conditioner 10 determines whether or not the refrigerant leakage detection process based on the first refrigerant detection control for the air conditioner 10 and the refrigerant leakage detection process based on the second refrigerant detection control need to be performed, but the control unit 22 of the edge device 20 may determine this instead.

According to the air-conditioner control system 1 of one embodiment of the present disclosure, for example, on days the air conditioner 10 is run, refrigerant leakage detection is performed based on the state of the refrigerant occurring when the air conditioner 10 is running. Also, with the air-conditioner control system 1 according to one embodiment of the present disclosure, for example, on days the air conditioner 10 is not run, refrigerant leakage detection is performed based on the refrigerant's pressure occurring when the air conditioner 10 is not running.

If the air conditioner 10 is not run for a number of days, the second refrigerant detection control can be executed, in which refrigerant leakage detection is performed by running the air conditioner 10 in the refrigerant leakage detection mode, such that the number Of days that follow after a refrigerant leakage detection is performed based on the refrigerant's pressure occurring when the air conditioner 10 is not running does not exceed the second predetermined period of time.

Although an embodiment Of the present disclosure has been described above, it should be understood that various changes in form and details can be made without departing from the spirit and scope of the accompanying claims. Although the present invention has been described above based on an embodiment, the present invention is by no means limited to the above embodiment and various modifications may be made within the scope of the accompanying claims. This application claims priority to Japanese Patent Application No. 2022-158318, filed with the Japan Patent Office on Sep. 30, 2022, the entire contents of which are incorporated herein by reference.

### REFERENCE SIGNS LIST

1 air-conditioner control system
10 air conditioner
12 inner unit
14 outer unit
16, 22, 32 control unit
20 edge device
30 server device
40 administrator terminal
50 network

1. An air-conditioner control system comprising a control unit for controlling an air conditioner, the control unit being configured to:
execute first refrigerant detection control, in which a refrigerant leakage detection for the air conditioner is performed every first predetermined period of time, based on a state of a refrigerant occurring when the air conditioner is running or based on a pressure of the refrigerant occurring when the air conditioner is not running; and
execute, when a second predetermined period of time has elapsed since the air conditioner was run last time, second refrigerant detection control, in which the refrigerant leakage detection for the air conditioner is performed while the air conditioner is running, for a refrigerant leakage detection purpose.

2. The air-conditioner control system according to claim 1, wherein the control unit is configured to perform the refrigerant leakage detection for the air conditioner based on the pressure of the refrigerant occurring when the air conditioner is not running, when the refrigerant leakage detection for the air conditioner based on the state of the refrigerant occurring when the air conditioner is running is not performed for the first predetermined period of time.

3. The air-conditioner control system according to claim 1, wherein the control unit is configured to execute control such that, when a result of the second refrigerant detection control indicates that the refrigerant is leaking, an indication to an effect that the refrigerant is leaking or a suggestion for an inspection of the air conditioner is sent to a predetermined destination.

4. The air-conditioner control system according to claim 1, wherein the second refrigerant detection control includes performing the refrigerant leakage detection for the air conditioner based on the state of the refrigerant for the air conditioner occurring when the air conditioner is running at a load that is 70% or more of a capacity of the air conditioner.

5. The air-conditioner control system according to claim 4, wherein the second refrigerant detection control includes performing the refrigerant leakage detection for the air conditioner based on the state of the refrigerant for the air conditioner occurring after the air conditioner is run at the load for a third predetermined period of time or longer.

6. The air-conditioner control system according to claim 1, wherein the second predetermined period of time is less than three months.

7. The air-conditioner control system according to claim 1, wherein the control unit records information indicating that the second refrigerant detection control has been executed.

8. An information processing apparatus comprising a control unit for controlling an air conditioner, the control unit being configured to:
execute first refrigerant detection control, in which a refrigerant leakage detection for the air conditioner is performed every first predetermined period of time, based on a state of a refrigerant occurring when the air conditioner is running or based on a pressure of the refrigerant occurring when the air conditioner is not running; and
execute, when a second predetermined period of time has elapsed since the air conditioner was run last time, second refrigerant detection control, in which the refrigerant leakage detection for the air conditioner is performed while the air conditioner is running, for a refrigerant leakage detection purpose.

9. An air-conditioner control method comprising:
executing first refrigerant detection control, in which a refrigerant leakage detection for an air conditioner is performed every first predetermined period of time, based on a state of a refrigerant occurring when the air conditioner is running or based on a pressure of the refrigerant occurring when the air conditioner is not running; and
executing, when a second predetermined period of time has elapsed since the air conditioner was run last time, second refrigerant detection control, in which the refrigerant leakage detection for the air conditioner is performed while the air conditioner is running for a refrigerant leakage detection purpose.
